(19) United States
(12) Patent Application Publication
(10) Pub. No.: US 2017/0356347 A1
(43) Pub. Date: Dec. 14, 2017

(54) ACCESSORY GEARBOX ASSEMBLY AND A GAS TURBINE ENGINE COMPRISING AN ACCESSORY GEARBOX ASSEMBLY

(71) Applicant: ROLLS-ROYCE plc, London (GB)

(72) Inventors: David P. SCOTHERN, Derby (GB); David A. EDWARDS, Derby (GB)

(73) Assignee: ROLLS-ROYCE plc, London (GB)

(21) Appl. No.: 15/600,917

(22) Filed: May 22, 2017

(30) Foreign Application Priority Data
Jun. 13, 2016 (GB) 1610234.5

(51) Int. Cl. F02C 7/32; F16H 1/22

(52) U.S. Cl. CPC F02C 7/32; F16H 1/22; F05D 2260/4031

(57) ABSTRACT

A gas turbine engine accessory gearbox assembly has an accessory gearbox and a plurality of accessories arranged to be driven by the accessory gearbox. The accessory gearbox has a gear train and an accessory gearbox casing enclosing the gear train gears. Each accessory is driven by a drive shaft and the drive shafts of the accessories may be parallel. Each accessory has a first end and a second opposite end. Each accessory is secured at the first end to the accessory gearbox casing, a plurality of accessories are secured to a first side of the accessory gearbox casing and the second opposite end of at least two of the plurality of accessories are secured to a structural cross member. The structural cross member increases the stiffness and strength of the accessory gearbox assembly and allows the accessory gearbox casing to be reduced in thickness and reduces weight and cost.

The present disclosure relates to an accessory gearbox assembly and in particular to an accessory gearbox assembly for a gas turbine engine.

An accessory gearbox assembly generally comprises an accessory gearbox and a plurality of accessories. The accessory gearbox comprises a gear train of spur gears, each of which is arranged to drive a respective one of the accessories. The accessories are either mounted on the front of the accessory gearbox, the back of the accessory gearbox or the front and the back of the accessory gearbox. The accessories include a low pressure fuel pump, a high pressure fuel pump, a fuel flow governor, an oil pump, a hydraulic pump, a starter motor, an electrical generator, a tachometer, a permanent magnet alternator, e.g. a permanent electrical generator. Thus, the accessory gearbox carries and drives the accessories. The accessory gearbox is driven by a drive shaft which extends generally radially with respect to the axis of the gas turbine engine from an internal gearbox driven by one or more shafts of the gas turbine engine.

The accessory gearbox is mounted on the fan casing of a turbofan gas turbine engine, for example at the bottom of the fan casing, or is mounted on the core engine casing of a turbofan gas turbine engine.

The accessory gearbox also comprises an accessory gearbox casing which encloses the gears of the gear train. In a conventional accessory gearbox the weight, inertia etc. of the accessories is carried by the gearbox casing. In a conventional accessory gearbox each accessory is secured, e.g. bolted, at one end to the accessory gearbox casing and thus each accessory is cantilevered off the accessory gearbox casing and thus each accessory acts as a parasitic mass hung off the accessory gearbox casing. Large accessories, e.g. electrical generators, transmit large loads into the accessory gearbox and accessory gearbox casing in response to movements of the gas turbine engine and/or accessory gearbox, especially following the unlikely event of a release of a fan blade from the fan of a turbofan gas turbine engine.

The accessory gearbox comprises for each accessory a gear and associated gear shaft mounted on the accessory gearbox casing by two bearings, e.g. two roller bearings, splines on the end of each gear shaft to drive the accessory, a seal where the gear shaft passes through the accessory gearbox casing, a shaft of the accessory supported on the accessory casing by two bearings, e.g. two roller bearings, splines on the shaft of the accessory which is arranged to mesh with the splines on the corresponding gear shaft and a seal where the shaft of the accessory passes through the casing of the accessory. Thus, there are a large number of component parts which adds weight and cost to the accessory gearbox assembly and increases the number of component parts which may fail.

The present disclosure seeks to provide an accessory gearbox assembly which reduces or overcomes the above mentioned problem(s).

According to a first aspect of the present disclosure there is provided an accessory gearbox assembly comprising an accessory gearbox and a plurality of accessories arranged to be driven by the accessory gearbox, the accessory gearbox comprising a gear train and an accessory gearbox casing enclosing the gears of the gear train, each accessory is driven by a drive shaft, each accessory has a first end and a second opposite end, each accessory is secured at the first end to the accessory gearbox casing and the second opposite end of at least two of the plurality of accessories are secured to a structural cross member.

A first plurality of accessories may be secured to a first side of the accessory gearbox casing, the drive shafts of the first plurality of accessories are parallel and the second opposite end of at least two of the first plurality of accessories are secured to a first structural cross member.

The at least two of the plurality of accessories may be the largest and/or the heaviest accessories secured to the first side of the accessory gearbox.

The largest and/or the heaviest accessories may be electrical generators.

The second opposite end of more than two of the plurality of accessories may be secured to the structural cross member.

The second opposite end of all the plurality of accessories may be secured to the structural cross member.

A second plurality of accessories may be secured to a second opposite side of the accessory gearbox casing, the drive shafts of the second plurality of accessories are parallel and the second opposite end of at least two of the second plurality of accessories are secured to a second structural cross member.

The second opposite end of more than two of the second plurality of accessories may be secured to the second structural cross member.

The second opposite end of all the second plurality of accessories may be secured to the second structural cross member.

The drive shaft of each accessory may be supported on an associated accessory casing by two bearings, the drive shaft of each accessory has at least one gear, the gear on the drive shaft of each accessory is arranged to mesh with one or more gears on the corresponding drive shaft of other accessories or the gear on the drive shaft of each accessory is arranged to mesh with one or more idler gears which mesh with the gears on the corresponding drive shaft of other accessories, the gear train comprises the gears on the drive shafts of the accessories, and the gears on the drive shafts of the accessories are all enclosed by the accessory gearbox casing of the accessory gearbox.

The accessory gearbox may comprise a gear and an associated drive shaft for each accessory, each drive shaft is supported on an associated accessory casing by two bearings, the gear on the drive shaft of each accessory is arranged to mesh with one or more gears on the corresponding drive shaft of other accessories, and the gears on the drive shafts of the accessories are all enclosed by the accessory gearbox casing of the accessory gearbox.

The accessory gearbox may comprise a gear and an associated gear shaft for each accessory, each gear shaft is mounted on the accessory gearbox casing by two bearings, each gear shaft has splines on an end of each gear shaft to drive the accessory, each accessory has a drive shaft supported on an associated accessory casing by two bearings, the drive shaft of each accessory has splines arranged to mesh with the splines on the corresponding gear shaft, the gear train comprises the gears for the associated accessories, and the gears, gear shafts and bearings for the gear shafts are all enclosed by the accessory gearbox casing of the accessory gearbox.

According to a second aspect of the present disclosure there is provided a gas turbine engine comprising an accessory gearbox assembly comprising an accessory gearbox and a plurality of accessories arranged to be driven by the accessory gearbox, the accessory gearbox comprising a gear train and an accessory gearbox casing enclosing the gears of the gear train, each accessory is driven by a drive shaft, each accessory has a first end and a second opposite end, each accessory is secured at the first end to the accessory gearbox casing and the second opposite end of at least two of the plurality of accessories are secured to a structural cross member.

A first plurality of accessories may be secured to a first side of the accessory gearbox casing, the drive shafts of the first plurality of accessories are parallel and the second opposite end of at least two of the first plurality of accessories are secured to a first structural cross member.

The at least two of the plurality of accessories may be the largest and/or the heaviest accessories secured to the first side of the accessory gearbox.

The largest and/or heaviest accessories may be electrical generators.

The second opposite end of more than two of the plurality of accessories may be secured to the structural cross member.

The second opposite end of all the plurality of accessories may be secured to the structural cross member.

A second plurality of accessories may be secured to a second opposite side of the accessory gearbox casing, the drive shafts of the second plurality of accessories are parallel and the second opposite end of at least two of the second plurality of accessories are secured to a second structural cross member.

The second opposite end of more than two of the second plurality of accessories may be secured to the second structural cross member.

The second opposite end of all the second plurality of accessories may be secured to the second structural cross member.

The drive shaft of each accessory may be supported on an associated accessory casing by two bearings, the drive shaft of each accessory has at least one gear, the gear on the drive shaft of each accessory is arranged to mesh with one or more gears on the corresponding drive shaft of other accessories or the gear on the drive shaft of each accessory is arranged to mesh with one or more idler gears which mesh with the gears on the corresponding drive shaft of other accessories, the gear train comprises the gears on the drive shafts of the accessories, and the gears on the drive shafts of the accessories are all enclosed by the accessory gearbox casing of the accessory gearbox.

The accessory gearbox may comprise a gear and an associated drive shaft for each accessory, each drive shaft is supported on an associated accessory casing by two bearings, the gear on the drive shaft of each accessory is arranged to mesh with one or more gears on the corresponding drive shaft of other accessories and the gears on the drive shafts of the accessories are all enclosed by the accessory gearbox casing of the accessory gearbox.

The accessory gearbox may comprise a gear and an associated gear shaft for each accessory, each gear shaft is mounted on the accessory gearbox casing by two bearings, each gear shaft has splines on an end of each gear shaft to drive the accessory, each accessory has a drive shaft supported on an associated accessory casing by two bearings, the drive shaft of each accessory has splines arranged to mesh with the splines on the corresponding gear shaft, the gear train comprises the gears for the associated accessories, and the gears, gear shafts and bearings for the gear shafts are all enclosed by the accessory gearbox casing of the accessory gearbox.

The gas turbine engine may be an aero gas turbine engine, a marine gas turbine engine, an industrial gas turbine engine or an automotive gas turbine engine.

The aero gas turbine engine may be a turbojet gas turbine engine, a turbo-propeller gas turbine engine, a turbo-shaft gas turbine engine or a turbofan gas turbine engine.

The accessory gearbox may be mounted on a fan casing of the turbofan gas turbine engine or the accessory gearbox may be mounted on a core engine casing of the turbofan gas turbine engine.

According to a third aspect of the present disclosure there is provided an accessory gearbox assembly comprising an accessory gearbox and a plurality of accessories arranged to be driven by the accessory gearbox, the accessory gearbox comprising a gear train and an accessory gearbox casing enclosing the gears of the gear train, each accessory has a drive shaft supported on an associated accessory casing by two bearings, the drive shaft of each accessory has at least one gear, the gear on the drive shaft of each accessory is arranged to mesh with one or more gears on the corresponding drive shaft of other accessories or the gear on the drive shaft of each accessory is arranged to mesh with one or more idler gears which mesh with the gears on the corresponding drive shaft of other accessories, the gear train comprises the gears on the drive shafts of the accessories, and the gears on the drive shafts of the accessories are all enclosed by the accessory gearbox casing of the accessory gearbox.

According to a fourth aspect of the present disclosure there is provided a gas turbine engine comprising an accessory gearbox assembly comprising an accessory gearbox and a plurality of accessories arranged to be driven by the accessory gearbox, the accessory gearbox comprising a gear train and an accessory gearbox casing enclosing the gears of the gear train, each accessory has a drive shaft supported on an associated accessory casing by two bearings, the drive shaft of each accessory has at least one gear, the gear on the drive shaft of each accessory is arranged to mesh with one or more gears on the corresponding drive shaft of other accessories or the gear on the drive shaft of each accessory is arranged to mesh with one or more idler gears which mesh with the gears on the corresponding drive shaft of other accessories, the gear train comprises the gears on the drive shafts of the accessories, and the gears on the drive shafts of the accessories are all enclosed by the accessory gearbox casing of the accessory gearbox.

The skilled person will appreciate that except where mutually exclusive, a feature described in relation to any one of the above aspects of the invention may be applied mutatis mutandis to any other aspect of the invention.

Embodiments of the invention will now be described by way of example only, with reference to the Figures, in which:

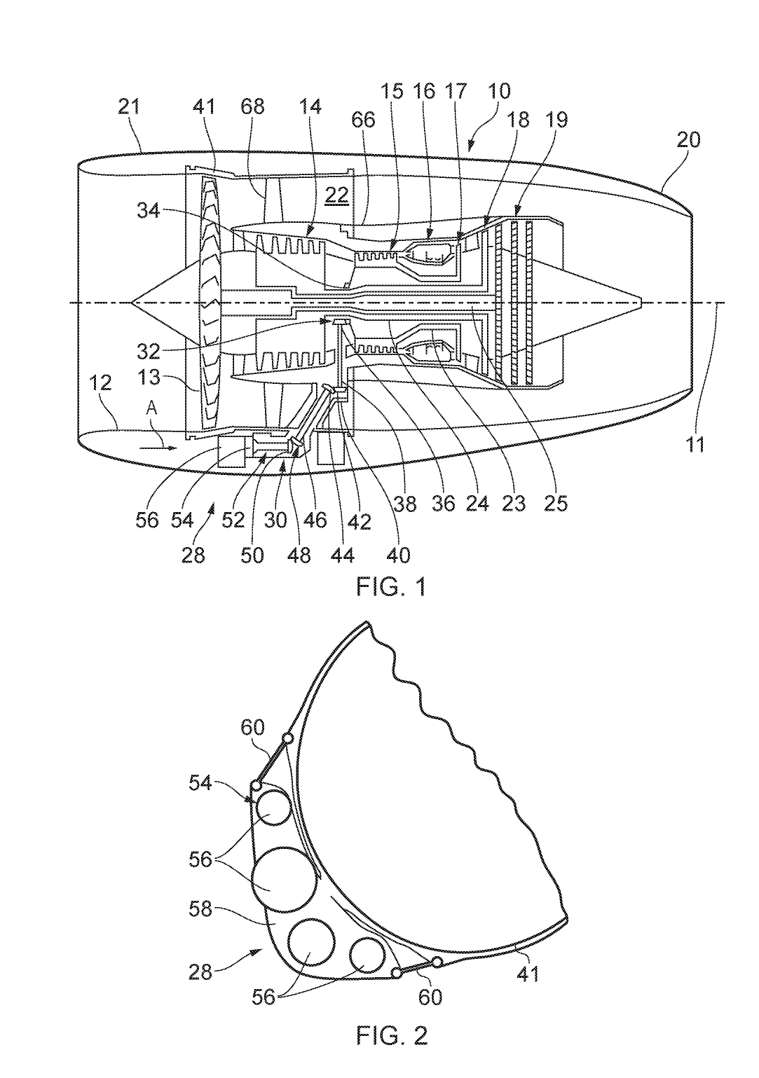

FIG. 1 is a sectional side view of a gas turbine engine having an accessory gearbox assembly according to the present disclosure.

FIG. 2 is an enlarged view in the direction of arrow A in FIG. 1.

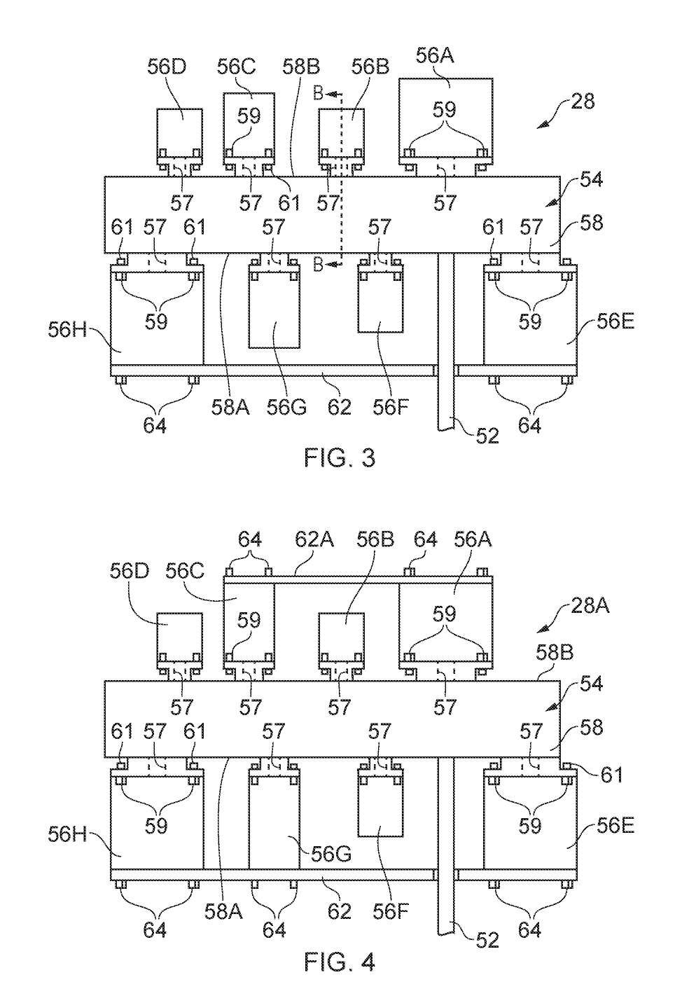

FIG. 3 is a schematic plan view of an accessory gearbox assembly according to the present disclosure.

FIG. 4 is a schematic plan view of a further accessory gearbox assembly according to the present disclosure.

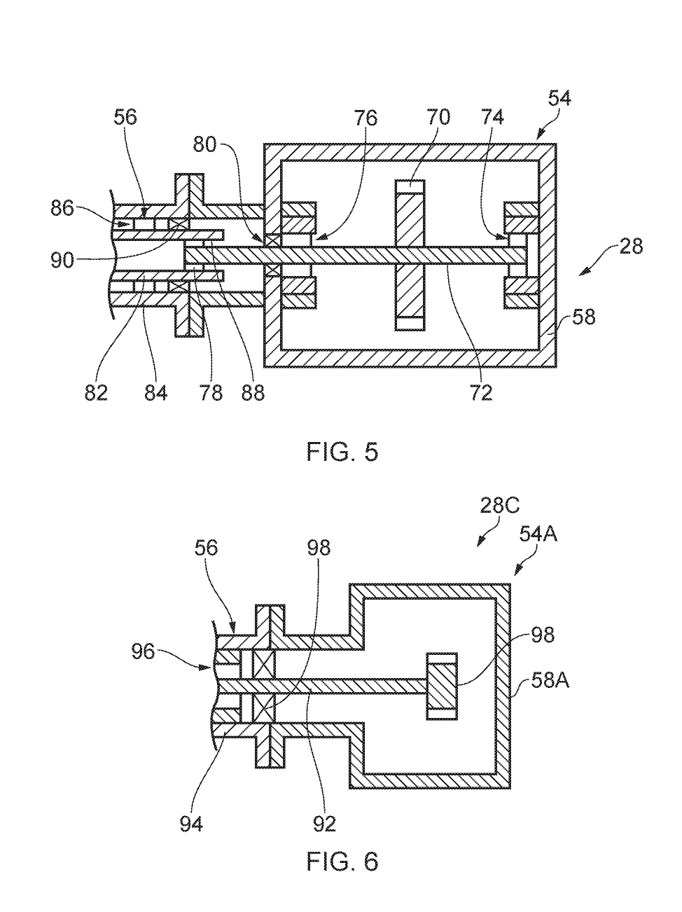

FIG. 5 is an enlarged schematic cross-sectional view along line B-B of FIG. 3.

FIG. 6 is an alternative enlarged schematic cross-sectional view along line B-B of FIG. 3.

With reference to FIG. 1, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, and intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shafts 23, 24 and 25 respectively.

The gas turbine engine 10 further comprises an accessory gearbox assembly 28. The accessory gearbox assembly 28 is drivingly connected to the shaft 23 connecting the high pressure compressor 15 and the high pressure turbine 17 via drive means 30. However, in other embodiments the accessory gearbox assembly 28 may be driven by the shaft 24 connecting the intermediate pressure compressor 14 and the intermediate pressure turbine 18 or by the shaft 25 connecting the fan 13 and the low pressure turbine 19. In this arrangement the drive means 30 comprises an internal gearbox 32 provided at the upstream end of the shaft 23. The internal gearbox 32 comprises a bevel gear 34 at the upstream end of the shaft 23 and a bevel gear 36 arranged on the radially inner end of a radial drive shaft 38. The bevel gear 36 on the radial drive shaft 38 is arranged to mesh with the bevel gear 34 on the shaft 23. The radial drive shaft 38 extends through a strut extending across the flow path from the intermediate pressure compressor 14 to the high pressure compressor 15.

An intermediate gearbox, alternatively known as a step aside gearbox, 40 is provided at the radially outer end of the radial drive shaft 38. The intermediate gearbox 40 comprises a bevel gear 42 on the radially outer end of the radial drive shaft 38 and a bevel gear 44 arranged on an inner end of a further drive shaft 46. In this example the further drive shaft 46 is an angled drive shaft. The bevel gear 42 on the radial drive shaft 38 is arranged to mesh with the bevel gear 44 on the further drive shaft 46. The further drive shaft 46 extends through a strut extending across the bypass duct 22. The casing of the intermediate gearbox 40 is mounted on the core engine casing 66. The core engine casing 66 is secured to a fan casing 41 which surrounds the fan 13 by a plurality of radially extending circumferentially spaced fan outlet guide vanes 68. The fan casing 41 is integrated into the structure of the nacelle 21.

A bevel gear 48 is provided on the radially outer end of the further drive shaft 46 and the bevel gear 50 is arranged to mesh with a bevel gear 50 on a final drive shaft 52. The final drive shaft 52 is arranged to provide drive for the accessory gearbox assembly 28. The accessory gearbox assembly 28 comprises an accessory gearbox 54 and a plurality of accessories 56 arranged to be driven by the accessory gearbox 54. The accessory gearbox 54 is mounted on the fan casing 41 and within the nacelle 21.

The accessory gearbox 54 is generally arcuate to correspond with the curvature of the fan casing 41, as shown in FIG. 2, and the opposite circumferential ends, with respect to the axis of the gas turbine engine 10, of the accessory gearbox 54 are secured by struts 60 extending from the accessory gearbox casing 58 to the fan casing 41. The accessory gearbox 54 may be secured to the fan casing 41 by other struts extending from the accessory gearbox casing 58 to the fan casing 41 between the ends of the accessory gearbox 54.

An arrangement of the accessory gearbox assembly 28 is shown more clearly in FIG. 3. The accessory gearbox assembly 28 comprises a gear train (not shown) and an accessory gearbox casing 58 enclosing the gears of the gear train. Each accessory 56 is driven by a drive shaft 57. Each accessory 56 has a first end and a second opposite end and each accessory 56 is secured at the first end to the accessory gearbox casing 58. In this arrangement the accessories 56 are secured to the accessory gearbox casing 58 by fasteners, e.g. bolts 59 and nuts, but other suitable fasteners, e.g. bolts and threaded inserts or screws, may be used. A plurality of accessories 56 are secured to a first side 58A of the accessory gearbox casing 58 and the second opposite end of at least two of the plurality of accessories 56 are secured to a structural cross member 62. The drive shafts 57 of the accessories 56 secured to the first side 58A of the accessory gearbox casing 58 are parallel. In this arrangement the accessories 56 are secured to the structural cross member 62 by fasteners, e.g. bolts 64 and threaded inserts, but other suitable fasteners, e.g. screws or bolts and nuts, may be used. The structural cross member 62 is spaced from the first side 58A of the accessory gearbox 54 and in this particular example is parallel to the first side 58A of the accessory gearbox 54.

The at least two of the plurality of accessories 56 are the largest and/or the heaviest accessories secured to the first side 58A of the accessory gearbox 54. The largest and/or heaviest accessories 56 may be electrical generators. In some arrangements the second opposite end of more than two of the plurality of accessories 56 are secured to the structural cross member 62 and in other arrangements the second opposite end of all the plurality of accessories 56 may be secured to the structural cross member 62.

A second plurality of accessories 56 are secured to a second opposite side 58B of the accessory gearbox casing 58 and the second opposite end of the second plurality of accessories 56 are unsupported. The drive shafts 57 of the second plurality of accessories 56 secured to the second opposite side 58B of the accessory gearbox casing 58 are parallel. In this arrangement the accessories 56 are secured to the accessory gearbox casing 58 by fasteners, e.g. bolts 59 and nuts, but other suitable fasteners, e.g. bolts and threaded inserts or screws, may be used.

The accessories 56 include a starter motor 56A, an oil pump 56B, a hydraulic pump 56C, a low pressure fuel pump 56D, an aircraft electrical generator 56E, a high pressure fuel pump 56F, an engine electrical generator 56G, a fuel flow governor 56G. Other accessories, for example a tachometer, a permanent magnet electrical generator, a permanent magnet alternator, to provide power to the engine electronic control unit (EEC) are also mounted on and driven by the accessory gearbox 54.

A further arrangement of the accessory gearbox assembly 28A is shown more clearly in FIG. 4. The accessory gearbox assembly 28 comprises a gear train (not shown) and an accessory gearbox casing 58 enclosing the gears of the gear train. Each accessory 56 is driven by a drive shaft 57. Each accessory 56 has a first end and a second opposite end and each accessory 56 is secured at the first end to the accessory gearbox casing 58. In this arrangement the accessories 56 are secured to the accessory gearbox casing 58 by fasteners, e.g. bolts 59 and nuts, but other suitable fasteners, e.g. bolts and threaded inserts or screws, may be used. A plurality of accessories 56 are secured to a first side 58A of the accessory gearbox casing 58 and the second opposite end of at least two of the plurality of accessories 56 are secured to a structural cross member 62. The drive shafts 57 of the accessories 56 secured to the first side 58A of the accessory gearbox casing 58 are parallel. In this arrangement the accessories 56 are secured to the structural cross member 62 by fasteners, e.g. bolts 64 and threaded inserts, but other suitable fasteners, e.g. screws or bolts and nuts, may be used. The structural cross member 62 is spaced from the first side 58A of the accessory gearbox 54 and in this particular example is parallel to the first side 58A of the accessory gearbox 54.

The at least two of the plurality of accessories 56 are the largest and/or the heaviest accessories secured to the first side 58A of the accessory gearbox 54. The largest and/or heaviest accessories 56 may be electrical generators. In some arrangements the second opposite end of more than two of the plurality of accessories 56 are secured to the structural cross member 62 and in other arrangements the second opposite end of all the plurality of accessories 56 may be secured to the structural cross member 62.

A second plurality of accessories 56 are secured to a second opposite side 58B of the accessory gearbox casing 58 and the second opposite end of at least two of the second plurality of accessories are secured to a second structural cross member 62A. The drive shafts 57 of the second plurality of accessories 56 secured to the second opposite side 58B of the accessory gearbox casing 58 are parallel. In this arrangement the accessories 56 are secured to the accessory gearbox casing 58 by fasteners, e.g. bolts 59 and nuts, but other suitable fasteners, e.g. bolts and threaded inserts or screws, may be used. In this arrangement the accessories 56 are secured to the structural cross member 62A by fasteners, e.g. bolts 64 and threaded inserts, but other suitable fasteners, e.g. screws or bolts and nuts, may be used. In some arrangements the second opposite end of more than two of the second plurality of accessories 56 may be secured to the second structural cross member 62A. In some arrangements the second opposite end of all the second plurality of accessories 56 may be secured to the second structural cross member 62A. The second structural cross member 62A is spaced from the second side 58B of the accessory gearbox 54 and in this particular example is parallel to the second side 58B of the accessory gearbox 54.

The accessories 56 include a starter motor 56A, an oil pump 56B, a hydraulic pump 56C, a low pressure fuel pump 56D, an aircraft electrical generator 56E, a high pressure fuel pump 56F, an engine electrical generator 56G, a fuel flow governor 56G. Other accessories, for example a tachometer, a permanent magnet electrical generator, a permanent magnet alternator, to provide power to the engine electronic control unit (EEC) are also mounted on and driven by the accessory gearbox 54.

The advantage of the present disclosure is that it uses the accessories themselves to increase the stiffness of the accessory gearbox assembly by connecting/linking the free ends of two or more of the accessories by a structural cross member. This ensures that the accessories contribute to the stiffness and strength of the accessory gearbox assembly. The free ends of the accessories are constrained and this reduces the displacements of the accessories and hence reduces the stresses the accessories induce within the accessory gearbox especially during extreme events, such as a fan blade off. This allows the accessory gearbox casing to be reduced in thickness, reducing weight and cost.

The accessory gearbox assembly 28 in one example, as shown in FIG. 5, comprises for each accessory 56 a gear 70 and associated gear shaft 72 mounted on the accessory gearbox casing 58 by two bearings, e.g. two roller bearings, 74 and 76 splines 78 on the end of each gear shaft 72 to drive the accessory 56 and a seal 80 where the gear shaft 72 extends through the accessory gearbox casing 58. A shaft 82 of the accessory 56 is supported on the accessory casing 84 by two bearings, e.g. two roller bearings, only one of which 86 is shown, splines 88 on the shaft 82 of the accessory 56 which are arranged to mesh with the splines 78 on the corresponding gear shaft 72 and a seal 90 where the shaft 82 of the accessory 56 passes through the casing 84 of the accessory 56. The gears 70, which are arranged to drive the accessories 56, are arranged to mesh to form a gear train. The gears 70, gear shafts 72 and bearings 74, 76 for the gear shafts 72 are all enclosed by the accessory gearbox casing 58 of the accessory gearbox 54. There may be idler gears supported on the accessory casing by two bearings, e.g. two roller bearings, between and meshing with the gears 70 which are arranged to drive the accessories 56. The gears 70, gear shafts 72 and bearings 74, 76 for the gear shafts 72, the idler gears and bearings are all enclosed by the accessory gearbox casing 58 of the accessory gearbox 54. In this arrangement the splines 78 extend radially outwardly from the gear shaft 72 and the splines 88 extend radially inwardly from the shaft 82, but the splines 78 may extend radially inwardly from the gear shaft 72 and the splines 88 may extend radially outwardly from the shaft 82.

The accessory gearbox assembly 28C in another example, as shown in FIG. 6, comprises a shaft 92 of the accessory 56 supported on the accessory casing 94 by two bearings, e.g. two roller bearings, only one of which 96 is shown, at least one gear 98 on the shaft 92 of the accessory 56 and a seal 98 where the shaft 92 of the accessory 56 extends through the casing 94 of the accessory 56. There may be a seal where the shaft 92 of the accessory 56 passes through the accessory gearbox casing 58A of the accessory gearbox 54A and the gear 98 on the shaft 92 of each accessory 56 is arranged to mesh with one or more gears 98 on the corresponding shaft 92 of other accessories 56 or mesh with one or more idler gears which mesh with the gears 98 on the corresponding shaft 92 of other accessories 56. Thus, the gears 98 mounted on the shafts 92 of the accessories 56 build up the gear train within the accessory gearbox casing 58A as the accessories 56 are mounted onto the accessory gearbox casing 58A. The apertures in the accessory gearbox casing 58A each have a diameter large enough to enable the gear 98 on the shaft 92 of the corresponding accessory 56 to pass there-through. The accessories are designed to support the gear train and to react the gear loads. This arrangement removes the requirement for gear shafts mounted on the accessory gearbox casing and bearings to mount the gear shafts on the accessory gearbox casing and within the gearbox itself. Mounting the drive gears on the accessories effectively reduces the accessory gearbox to a slim and light weight accessory gearbox casing to contain lubricant, oil, and provide the gear train lubrication system and this would enable a significant cost and weight reduction.

Although the present disclosure has referred to the drive shafts of the accessories being arranged parallel at the first and second sides of the accessory gearbox it may be possible to provide one or more accessories which have a drive shaft arranged at another angle, for example an accessory may be provided at an end of the accessory gearbox, or at an arcuate side of the accessory gearbox, and driven for example by a bevel gear and the second end of such an accessory may also be secured to a structural cross member.

Although the present disclosure has been described with the use of removable fasteners to secure the accessories to the structural cross member and the second structural cross member it may be equally possible to the weld, braze or bond one or more of the accessories to the structural member and/or to the second structural member. The structural member and/or the second structural member may comprise a suitable material for example a metal, e.g. steel, titanium, aluminium etc., or a composite material, a fibre reinforced material, e.g. a metal matrix composite.

Although the present disclosure has been described with reference to the accessories in particular positions with respect to the accessory gearbox it is equally possible to provide each of them at any other suitable position.

Although the present disclosure has been described with reference to mounting the accessory gearbox on the fan casing it may be equally possible to mount the accessory gearbox on the core engine casing.

Although the present invention has been described with reference to a turbofan gas turbine engine, it is equally applicable to a turbojet gas turbine engine, a turbo-shaft gas turbine engine and a turbo-propeller gas turbine engine. Although the present invention has been described with reference to an aero gas turbine engine it is equally applicable to a marine gas turbine engine, an industrial gas turbine engine and an automotive gas turbine engine or other type of turbomachine.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. An accessory gearbox assembly comprising an accessory gearbox and a plurality of accessories arranged to be driven by the accessory gearbox, the accessory gearbox comprising a gear train and an accessory gearbox casing enclosing the gears of the gear train, each accessory is driven by a drive shaft, each accessory has a first end and a second opposite end, each accessory is secured at the first end to the accessory gearbox casing and the second opposite end of at least two of the plurality of accessories are secured to a structural cross member.

2. An accessory gearbox assembly as claimed in claim 1 wherein a first plurality of accessories are secured to a first side of the accessory gearbox casing, the drive shafts of the first plurality of accessories are parallel and the second opposite end of at least two of the first plurality of accessories are secured to a first structural cross member.

3. An accessory gearbox assembly as claimed in claim 1 wherein the at least two of the plurality of accessories are the largest accessories secured to the first side of the accessory gearbox.

4. An accessory gearbox assembly as claimed in claim 3 wherein the largest accessories are electrical generators.

5. An accessory gearbox assembly as claimed in claim 1 wherein the at least two of the plurality of accessories are the heaviest accessories secured to the first side of the accessory gearbox.

6. An accessory gearbox assembly as claimed in claim 5 wherein the heaviest accessories are electrical generators.

7. An accessory gearbox assembly as claimed in claim 1 wherein the second opposite end of more than two of the plurality of accessories are secured to the structural cross member.

8. An accessory gearbox assembly as claimed in claim 1 wherein the second opposite end of all the plurality of accessories are secured to the structural cross member.

9. An accessory gearbox assembly as claimed in claim 1 wherein a second plurality of accessories are secured to a second opposite side of the accessory gearbox casing, the drive shafts of the second plurality of accessories are parallel and the second opposite end of at least two of the second plurality of accessories are secured to a second structural cross member.

10. An accessory gearbox assembly as claimed in claim 9 wherein the second opposite end of more than two of the second plurality of accessories are secured to the second structural cross member.

11. An accessory gearbox assembly as claimed in claim 9 wherein the second opposite end of all the second plurality of accessories are secured to the second structural cross member.

12. An accessory gearbox assembly as claimed in claim 1 wherein the drive shaft of each accessory is supported on an associated accessory casing by two bearings, the drive shaft of each accessory has at least one gear, the gear on the drive shaft of each accessory is arranged to mesh with one or more gears on the corresponding drive shaft of other accessories or the gear on the drive shaft of each accessory is arranged to mesh with one or more idler gears which mesh with the gears on the corresponding drive shaft of other accessories, the gear train comprises the gears on the drive shafts of the accessories, and the gears on the drive shafts of the accessories are all enclosed by the accessory gearbox casing of the accessory gearbox.

13. An accessory gearbox assembly as claimed in claim 1 wherein the accessory gearbox comprises a gear and an associated gear shaft for each accessory, each gear shaft is mounted on the accessory gearbox casing by two bearings, each gear shaft has splines on an end of each gear shaft to drive the accessory, each accessory has a drive shaft supported on an associated accessory casing by two bearings, the drive shaft of each accessory has splines arranged to mesh with the splines on the corresponding gear shaft, the gear train comprises the gears for the associated accessories, and the gears, gear shafts and bearings for the gear shafts are all enclosed by the accessory gearbox casing of the accessory gearbox.

14. A gas turbine engine comprising an accessory gearbox assembly as claimed in claim 1.

15. A gas turbine engine as claimed in claim 14 wherein the gas turbine engine is an aero gas turbine engine.

16. A gas turbine engine as claimed in claim 14 wherein the gas turbine engine is a turbofan gas turbine engine.

17. A gas turbine engine as claimed in claim 16 wherein the turbofan gas turbine engine has a fan casing, the accessory gearbox is mounted on the fan casing of the turbofan gas turbine engine.

18. A gas turbine engine as claimed in claim 16 wherein the turbofan gas turbine engine has a core engine casing, the accessory gearbox is mounted on the core engine casing of the turbofan gas turbine engine.

19. An accessory gearbox assembly comprising an accessory gearbox and a plurality of accessories arranged to be driven by the accessory gearbox, the accessory gearbox comprising a gear train and an accessory gearbox casing enclosing the gears of the gear train, each accessory has a drive shaft supported on an associated accessory casing by two bearings, the drive shaft of each accessory has at least one gear, the gear on the drive shaft of each accessory is arranged to mesh with one or more gears on the corresponding drive shaft of other accessories or the gear on the drive shaft of each accessory is arranged to mesh with one or more idler gears which mesh with the gears on the corresponding drive shaft of other accessories, the gear train comprises the gears on the drive shafts of the accessories, and the gears on the drive shafts of the accessories are all enclosed by the accessory gearbox casing of the accessory gearbox.

20. A gas turbine engine comprising an accessory gearbox assembly comprising an accessory gearbox and a plurality of accessories arranged to be driven by the accessory gearbox, the accessory gearbox comprising a gear train and an accessory gearbox casing enclosing the gears of the gear train, each accessory has a drive shaft supported on an associated accessory casing by two bearings, the drive shaft of each accessory has at least one gear, the gear on the drive shaft of each accessory is arranged to mesh with one or more gears on the corresponding drive shaft of other accessories or the gear on the drive shaft of each accessory is arranged to mesh with one or more idler gears which mesh with the gears on the corresponding drive shaft of other accessories, the gear train comprises the gears on the drive shafts of the accessories, and the gears on the drive shafts of the accessories are all enclosed by the accessory gearbox casing of the accessory gearbox.
